(19) United States
(12) Patent Application Publication
(10) Pub. No.: US 2018/0214253 A1
(43) Pub. Date: Aug. 2, 2018

(54) DENTAL IMPLANT CROWN ABUTMENT WITH INDEXED MARGIN

(71) Applicant: Richard Guerra, Chicago, IL (US)

(72) Inventor: Richard Guerra, Chicago, IL (US)

(21) Appl. No.: 15/885,420

(22) Filed: Jan. 31, 2018

Related U.S. Application Data
(60) Provisional application No. 62/452,772, filed on Jan. 31, 2017.

(51) Int. Cl. A61C 8/00; A61C 5/70

(52) U.S. Cl. CPC A61C 8/0066; A61C 8/0001; A61C 13/0004; A61C 8/0068; A61C 8/0051; A61C 5/70

(57) ABSTRACT

A dental implant abutment comprising: a crown seating portion located toward a first end of the abutment; a fixture seating portion located toward a second end of the abutment; and a main body located between the crown seating portion and the fixture seating portion, the main body including an external indexing feature located along an outer perimeter of the main body at a transition between the main body and the crown seating portion, the external indexing feature comprising an elevational variance of the outer perimeter of the main body that mates with a visually identifiable elevational variance of a mating surface of a crown with which the dental implant abutment mates.

### BACKGROUND OF THE INVENTION

The present subject matter relates generally to a dental implant crown abutment and methods for matching a dental implant with a crown abutment and a crown. More specifically, the present invention known as indexed margin crown abutment relates to a crown abutment having an indexed margin and describes methods for matching a dental implant with an indexed margin crown abutment for the production of a custom crown.

Typically, stock implant crown abutments are ordered by the marginal height for example a 3 mm abutment has a marginal height 3 mm from the implant and abutment connection. The marginal height of a stock crown abutment is almost always uniform except for anatomic stock abutments where the marginal height is greater in a segment of the margin to match a higher tissue level. Crown abutments for dental implants often include indexed portions along the axial surface of the abutment (corresponding to the internal surface of the crown) intended to aid in retention and serve to reduce rotation between the abutment and crown. In those abutments, a user cannot assess the orientation between the abutment and the crown when the crown is in place. If the tolerances are not very tight between the crown and the abutment (i.e., there is slop in the fit), a user may not properly seat the crown to the abutment and will not have the option of cementing the crown extra orally.

Accordingly, there is a need for dental implant crown abutments having an indexed margin. The indexed margin crown abutment can be mass produced and its dimensions can be incorporated in software. This allows virtually matching the dental implant position to the indexed margin crown abutment allowing a custom crown to be fabricated on a mass-produced abutment without the use of a physical model. Eliminating the use of a physical model reduces lab time, reduces material use such as stone and impression material and reduces costs to produce a custom crown.

### BRIEF SUMMARY OF THE INVENTION

The present invention is a dental implant crown abutment having a margin which features one or more changes in elevation of the margin prominent enough to be anti-rotational, to assist the crown into its proper position and to allow inspection visually or with an instrument to verify proper seating of the crown onto the abutment. The indexing at the margin of the indexed margin crown abutment is intended to be anti-rotational (minimize or eliminate rotation between crown and abutment) and a visual cue to verify proper seating of the crown onto the abutment. This indexed margin crown abutment is meant to be mass produced and offered as a stock abutment which is a lower cost alternative to a milled or cast custom abutment. Again, in a typical 3 mm stock abutment the marginal height is a uniform 3 mm from the abutment implant connection. However, in the indexed margin crown abutment a 3 mm margin would have one or more indexing areas of the margin where the marginal height rises or falls prominently enough over a segment of the margin to be anti-rotational and guide the crown to its proper position. In this invention, the indexed margin actually guides the crown into its proper position and reduces or eliminates rotation once the crown is fully seated.

An indexed margin crown abutment allows for extra oral cementation and allows for verification of proper abutment and crown orientation. Extra oral cementation prevents a major complication of implant dentistry which is excess cement extruded into surrounding tissues. Because stock abutments typically have a uniform marginal height and typically the crown has a slight amount of rotation about the abutment, it is not possible to determine whether the crown and abutment are properly seated unless the margin is indexed. The fit between the indexed margin crown abutment and the crown is visible even when the crown is in place on the abutment allowing assessment of whether the crown is properly seated. Most abutments have an indexed axial surface, but users cannot verify proper orientation with crown because the indexed surface is covered by the crown once cemented or tried in.

In an embodiment, the indexed margin crown abutment may include and be used as a ti-base, a stock mass-produced abutment, and a stock mass produced angled abutment. The abutment can also be marked with lines to better assist in extra oral cementation. The indexed margin crown abutment features an elevation change or changes on the margin of the abutment that engages with a corresponding margin of a crown. In various embodiments, the indexed margin crown abutment may have different gingival heights, and different gingival profiles. The indexed crown abutment is not limited to a particular design at the margin as different geometries and arrangement of the elevation change or changes at the margin will be developed, tested and produced. Axial surface design for our illustrations was kept simple to highlight the properties of the margin and the invention is independent of the design of the axial surface. It will be understood by those of ordinary skill in the art that an indexed margin crown abutment may be adapted to most pre-existing implant platforms wherein the implant and abutment engage with each other, especially those that use a screw retained abutment. Although the illustrations depict an internal hex connection, the invention is not limited to any particular implant platform.

In various embodiments, the indexed margin on the abutment may take different forms. For example, in an embodiment, the indexed margin may be a simple elevation change extending away or towards the implant abutment connection. In another embodiment, the indexed margin may include multiple elevation changes extending away or towards the implant abutment connection. These indexes are not limited to a geometry and it is important to note that the index is differentiated from an anatomic abutment which has an elevation change to suit higher tissue level and this elevation change is not prominent enough to verify fit.

The indexed margin of the abutment creates a unique fit between the abutment and crown at the margin and can take many shapes. The key is to have a margin that allows for visual inspection or inspection by an explorer that the crown is properly seated on the abutment. The margin also guides the crown into proper position. Laser lines may be incorporated onto the abutment surface to aid in proper orientation for extra oral cementation.

The indexed margin of the abutment does not necessarily relate to anatomic shape or contour of gingival tissue. In all forms and variation, the indexing margin design will minimize rotation of crown on abutment, the margin will assist in proper positioning of the crown and allow for verification at margin and thus proper seating of crown.

In an embodiment, the present invention may be part of a system where using a CT scan, software used to create a surgical plan with surgical guide will incorporate the indexed margin crown abutment as part of the restorative plan. The final restorative measurement can then be taken with a scan body which allows a practitioner to create a virtual model to replicate the position of the implant allowing the mass produced indexed margin crown abutment to be positioned virtually and a crown designed virtually. In such a case, an end user can expect a near perfect marginal fit due to the known dimensions of the mass produced indexed margin crown abutment and the ability to mill a crown to match the dimensions of the mass produced indexed margin crown abutment. Conventional implant level measurements can also be used with impression material and a coping or a scan body to create a physical model to use the mass produced indexed margin crown abutment. It is important to note the mass produced indexed margin abutment will be designed in such a manner to reduce the need for preparation other than overall height of abutment allowing crowns to be designed to the known dimensions of the abutment ensuring accurate fit and proper retention. Adjusting overall height of the mass produced indexed stock abutment to replicate any changes made on a digital or physical model is considered an easy to replicate task and can be aided by a reduction coping.

Another embodiment of the present invention may include a dental implant abutment comprised of a crown seating portion located toward a first end of the abutment; a fixture seating portion located toward a second end of the abutment; and a main body located between the crown seating portion and the fixture seating portion, the main body including an external indexing feature located along an outer perimeter of the main body at a transition between the main body and the crown seating portion, the external indexing feature comprising an elevational variance of the outer perimeter of the main body that mates with a visually identifiable elevational variance of a mating surface of a crown with which the dental implant abutment mates.

This embodiment may further include a visually identifiable elevational variance of the outer perimeter of the main body extends toward the crown seating portion. This visually identifiable elevational variance of the outer perimeter of the main body may extend away from the crown seating portion. There may also be at least two visually identifiable elevational variances of the outer perimeter of the main body. When at least two visually identifiable elevational variances are present, one visually identifiable elevational variance may extend towards the crown seating portion and one visually identifiable elevational variance may extend away from the crown seating portion. The two (or more) visually identifiable elevational variances may also extend towards the crown seating portion.

This embodiment may yet also include a crown seating portion which further includes an internal alignment feature corresponding with an internal alignment surface of the crown with which the dental implant abutment mates such that, when the internal alignment feature of the crown seating portion of the abutment aligns with the internal alignment surface of the crown, the dental implant abutment indexing feature aligns with the visually identifiable elevational variance of the mating surface of the crown. The internal alignment surface of the crown and dental implant abutment alignment surface may both be flat in this or other embodiments.

An object of the invention is to provide a solution to the excessive cost and time requirements of present day dental implant abutment customization. An impression of an abutment or scan of an abutment leave open the chance for a poor marginal fit. Additionally, the cost of creating custom abutments means the present systems, methods, and processes for creating custom abutments are inefficient and onerous.

An advantage of the present invention is that it enables dental healthcare providers to cut costs by utilizing preformed dental implant components that can be mass produced. The use of computerized modeling provides the ability to utilize mass produced abutments while still ensuring a proper fit with the implant, and custom-made crown. Such a system also eliminates lab time in producing custom abutments or modifications to non-indexed stock abutments.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a side elevation of a restored dental implant which utilizes a preformed abutment.

FIG. 2A is top plan of a preformed abutment.

FIG. 2B is a top plan of a preformed abutment featuring two external indexing features.

FIG. 2C is a top plan of a preformed abutment featuring three external indexing features.

FIG. 2D is a bottom plan of a preformed abutment.

FIG. 3A is perspective view of a preformed abutment.

FIG. 3B is perspective view of a preformed abutment with an alternative external indexing feature.

FIG. 4 is a flow chart of how an indexed margin crown abutment may be used in the restoration of a dental implant.

FIG. 5A is a side elevation of a restored dental implant which utilizes a preformed abutment 21 with an external indexing feature and internal alignment feature.

FIG. 5B is top plan of a preformed abutment with an external indexing feature and alignment indexing feature.

FIG. 5C is a bottom plan of a preformed abutment.

FIG. 6A is a side elevation of a restored dental implant which utilizes a preformed abutment with two external indexing features 30 and internal alignment feature.

FIG. 6B is top plan of a preformed abutment with two external indexing features and internal alignment feature.

FIG. 6C is a bottom plan of a preformed abutment.

FIG. 7A is perspective view of a preformed abutment with an external indexing feature and internal alignment feature.

FIG. 7B is perspective view of a preformed abutment with two external indexing features and an internal alignment feature.

### DETAILED DESCRIPTION OF THE INVENTION

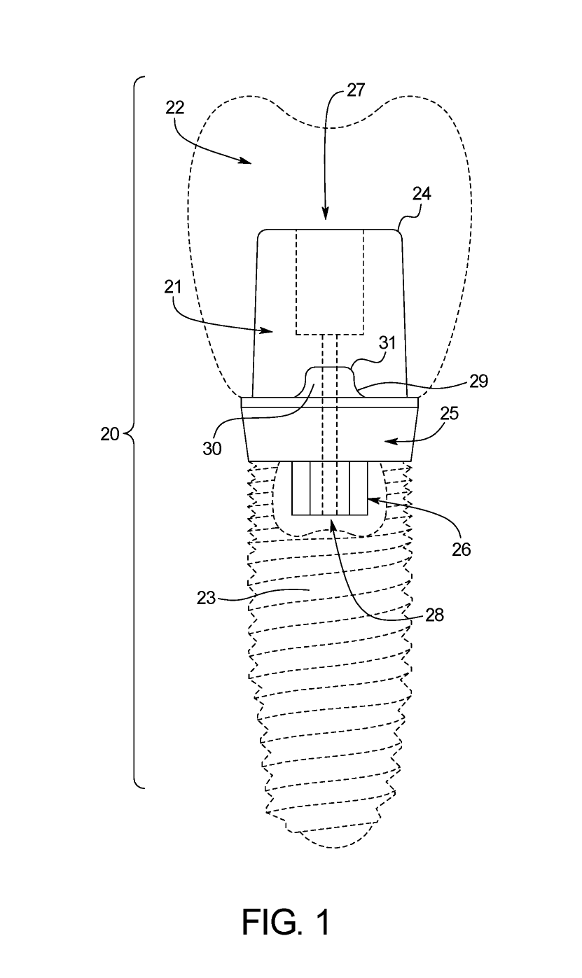

FIG. 1 is a side elevation view of a restored dental implant 20 which utilizes a preformed abutment 21. As shown in FIG. 1, an appropriately sized abutment 21 will support and fit properly with a custom crown 22. Such a proper fit is ensured visually in this embodiment by the use of an external indexing feature 30 (in this case a tail bump) which enables a dental care provider to visually line up the crown 22 and abutment 21 within the mouth. The external indexing feature 30 is an elevational variance in the abutment margin 29 which mates with a complementary elevational variance on the crown margin 31. This alignment ensures a secure, flush, and proper fit between all components of the completed dental implant restoration 20.

In the embodiment shown in FIG. 1, the external indexing feature 30 extends from the top face of the abutment margin 29 towards a first end 27 and is accommodated by a correspondingly sized groove in the crown margin 31. The abutment margin 29 acts as a transition point between crown setting upper portion 24 of the abutment 21 and main body 25 of the abutment 21 and is the surface against which the crown margin 31 mates. The abutment margin 29 is located around the perimeter of the abutment 21. The abutment 21 also features a lower fixture setting portion 26 (located towards a second end 28) which enables the abutment 21, and crown 22, when attached, to be joined with a fixture (in this case a threaded portion 23).

The dental implant 20 is held within the jawbone of a patient via a threaded portion 23 which mates with the bottom of the abutment 21. It should be noted that the threaded portion 23 is the only portion of the complete dental implant 20 (comprised of the crown 22, abutment 21, and threaded portion 23) actually implanted within the jaw of a patient. The other portions sit upon this implanted threaded portion 23 when constructing the complete dental implant 20. The abutment 21, crown 22, and threaded portion 30 may be constructed of any materials appropriate for dental implantation including 3-D printed materials.

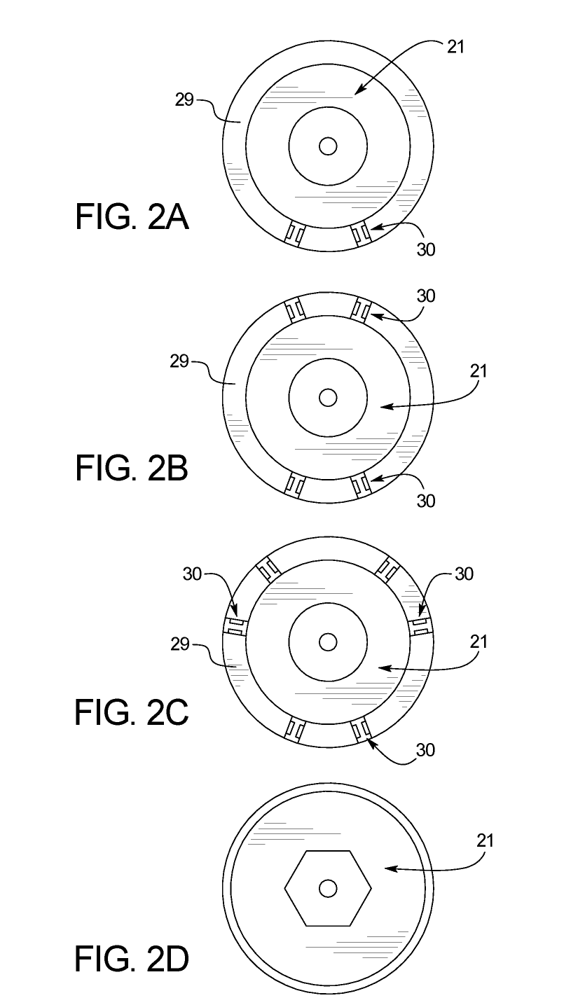

FIG. 2A is top plan view of a preformed abutment 21. As shown in FIG. 2A a preformed abutment 21 may have on the top face of the abutment margin 29 a number of external indexing features 30 (e.g., a single indicator 30 in FIG. 2A, two indicators 30 in FIG. 2B, and three indicators 30 in FIG. 2C). The abutment margin 29, in this example, is the area located at or near the furthest area from the center of the abutment 21 around the abutment's 21 midline perimeter.

FIG. 2B is a top plan view of a preformed abutment 21 featuring two external indexing features 30. As shown in FIG. 2B, the external indexing features 30 for this preformed abutment 21 are located parallel to one another in opposites locations around the abutment margin 29. The use of two external indexing features 30 may assist in ease of crown 22 fitting by both tactile response (e.g., more indicators to feel) and visual recognition (e.g., more indicators 30 to see).

FIG. 2C is a top plan view of a preformed abutment 21 featuring three external indexing features 30. As shown in FIG. 2B, the external indexing features 30 for this preformed abutment 21 are located equidistant to one another at locations around the abutment margin 29. The use of three external indexing features 30 may assist in ease of crown 22 fitting by both tactile response (e.g., more indicators to feel) and visual recognition (e.g., more indicators 30 to see).

FIG. 2D is a bottom plan view of a preformed abutment 21. As shown in FIG. 2D, the preformed abutment 21 is not limited to a particular platform and will be adapted to fit other existing dental implant platforms. The threaded portion 23 of the dental implant 20 shown in FIG. 1 is just one of many different platforms via which the abutment 21 (and crown 22) may be mounted within a patient's mouth.

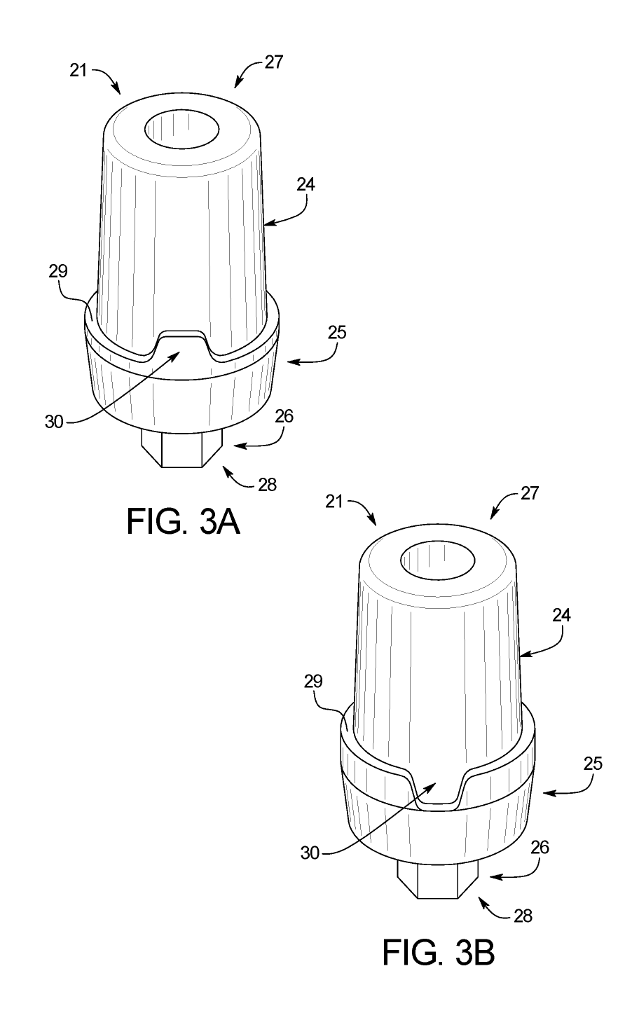

It should be noted the external indexing features 30 shown in FIGS. 2A-2C are example embodiments of the external indexing features 30 possibly utilized by the present invention. The external indexing features 30 may be bumps extending from the top face of the abutment margin 29 as shown but can also be square or angular in shape or even grooves or divots in the top face of the abutment margin 29 (see FIG. 3B) or any other shape which enables easier alignment of crown 22 and abutment 21. It is contemplated that any visually identifiable topographical feature may be used for the external indexing features 30.

FIG. 3A is perspective view of a preformed abutment 21. As shown in FIG. 3A, the preformed abutment 21 may feature on its exterior one or more external indexing features 30 (in FIG. 3A a bump and FIG. 3B a divot or groove). The external indexing feature 30 in this example is a bump located on the abutment's 21 abutment margin 29. A crown 22 will fit over this abutment 21, with the external indexing feature 30 fitting into a correspondingly sized groove in the crown 22.

FIG. 3B is perspective view of a preformed abutment 21 with an alternative external indexing feature 30. As shown in FIG. 3B, the preformed abutment 21 may feature on its exterior one or more external indexing features 30. The external indexing feature 30 in this example is a divot or groove located on the abutment margin 29. A crown 22 will fit over this abutment 21, with the external indexing feature 30 being filled by a correspondingly sized bump along the crown margin 31.

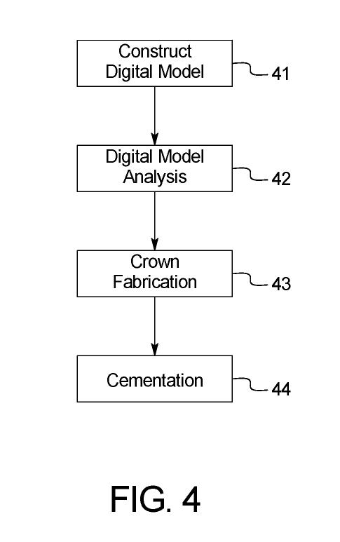

FIG. 4 is a flow chart of how an indexed margin crown abutment 21 may be used in the creation or restoration of a dental implant 20. As shown in FIG. 4, a system for matching a threaded portion 23 to an indexed margin stock abutment 21 and finally a custom crown 22 may feature a digital intraoral scanner which communicates with a computer. The digital scanner captures images information regarding a patient's teeth (step 41) via intraoral or physical impression scan. This information is then transmitted to the computer (which can be any sort of computing device including a desktop computer, laptop, tablet, smartphone, server, etc.) and a virtual model is created. The virtual model can be used to determine which particular indexed margin crown abutment (e.g., abutment 21, etc.) to use for the patient's dental implant restoration 20 (step 42). Next, a custom-made crown 22 can be produced (step 43) via milling or 3-D printing; the crown 22 fitting the parameters of the abutment margin 29 and intraoral parameters captured by the system such as crown form occlusion and contacts. The custom-made crown 22 is then cemented into the patient's mouth (step 44). For traditional screw access hole crowns, cementation is done either extra-orally or intraorally with removal of the crown 22 required to inspect for excess oral cement. Alternatively, for non-screw hole crowns (e.g., those featuring index indicator(s) 30) crown cementation can be done intraorally, with the external indexing indicator(s) 30 ensuring a properly seated crown 22.

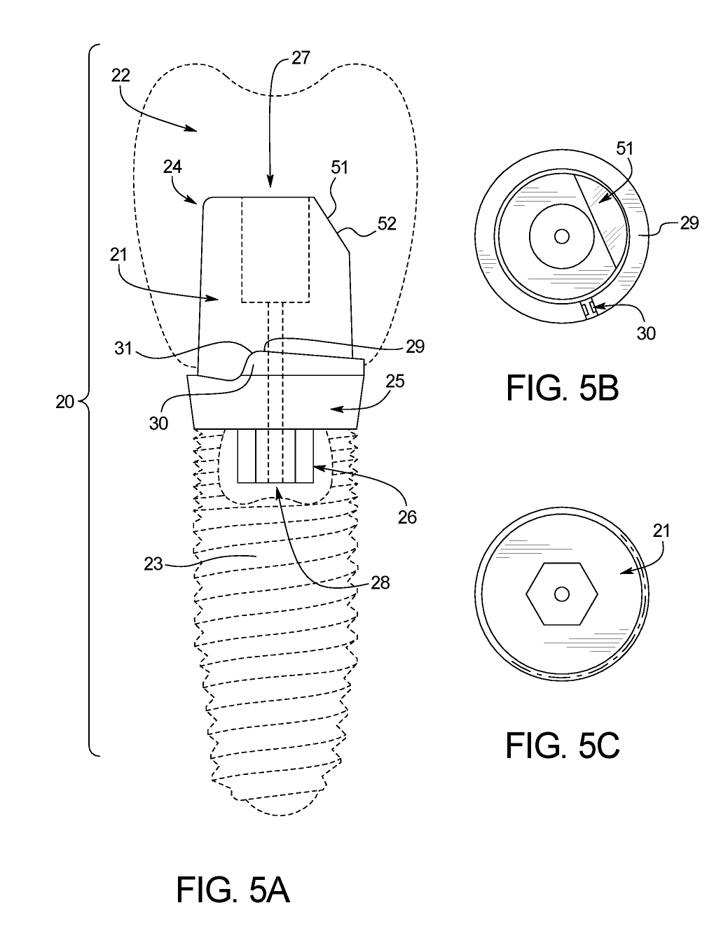

FIG. 5A is a side elevation view of a restored dental implant 20 which utilizes a preformed abutment 21 with an external indexing feature 30 and internal alignment feature 51. In the example shown in FIG. 5A, the preformed abutment 21 features a wave-like shaped external indexing indicator 30. In this embodiment, proper seating of the crown portion 22 is also aided by an abutment alignment surface 51 (one example of an internal alignment feature 51). The abutment alignment surface 51 mates with a corresponding internal alignment surface 52 of the crown 22 to ensure proper fit of the crown 22 while also preventing rotation of crown 22 within the mouth of a patient. This dental implant 20 is affixed within such a patient's mouth via the threaded portion 23. Having both internal and external mating surfaces further promotes the proper alignment between the abutment 21 and the crown 22.

FIG. 5B is top plan view of a preformed abutment 21 with an external indexing feature 30 and internal alignment feature 51. As shown in FIG. 5B a preformed abutment 21 may have on the top face of the abutment margin 29 any number of external indexing features 30. The abutment margin 29, in this example, is the area located at or near the furthest area from the center of the abutment 21 around the abutment's 21 perimeter, which forms the ledge against the crown margin 31 fits.

FIG. 5C is a bottom plan view of a preformed abutment 21. The preformed abutment 21 is not limited to a particular platform and can be adapted to fit other existing dental implant platforms, fixtures, etc.

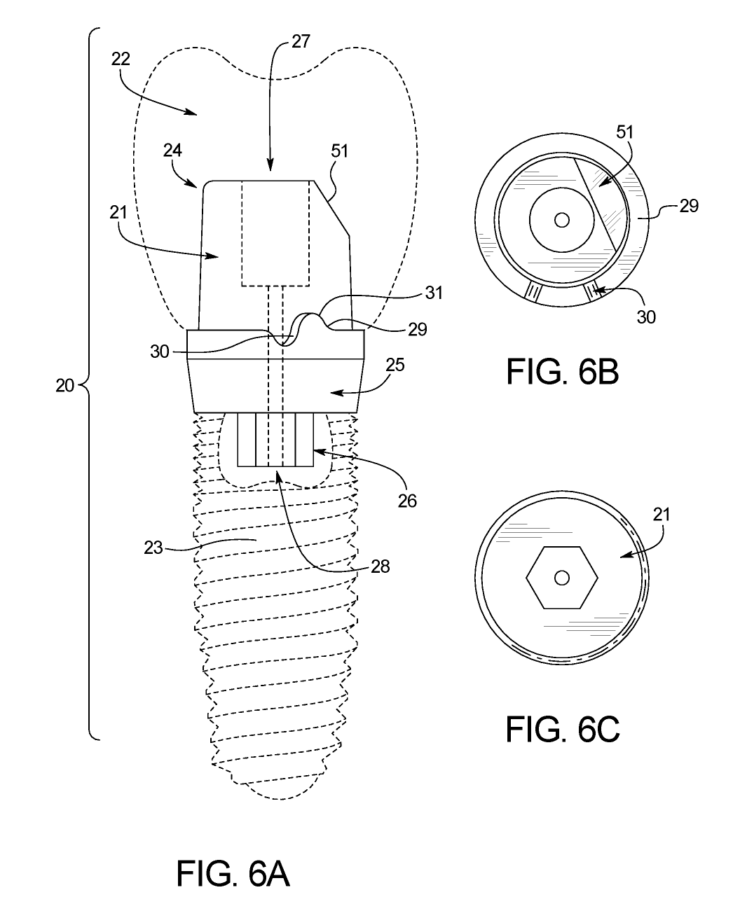

FIG. 6A is a side elevation view of a restored dental implant 20 which utilizes a preformed abutment 21 with two external indexing features 30 and internal alignment feature 51. As shown in FIG. 5A, the preformed abutment 21 may feature multiple external indexing indicators (in this case a bump and divot) which enables correct seating of the crown 22. In this embodiment, proper seating of the crown portion 22 is also aided by an abutment alignment surface 51. The abutment alignment surface 51 mates with a corresponding internal alignment surface 52 of the crown 22 to ensure proper fit of the crown while also preventing rotation of crown 22 within the mouth of a patient. This dental implant 20 is affixed to the fixture 23 within the patient's mouth.

FIG. 6B is top plan view of a preformed abutment 21 with two external indexing features 30 and internal alignment feature 51. As shown in FIG. 5B a preformed abutment 21 may have on the top face of the abutment margin 29 any number of external indexing features 30. In this example, the external indexing features 30 are located next to one another (a bump and divot).

FIG. 6C is a bottom plan view of a preformed abutment 21. The preformed abutment 21 is not limited to a particular platform and will be adapted to fit other existing dental implant platforms, fixtures, etc.

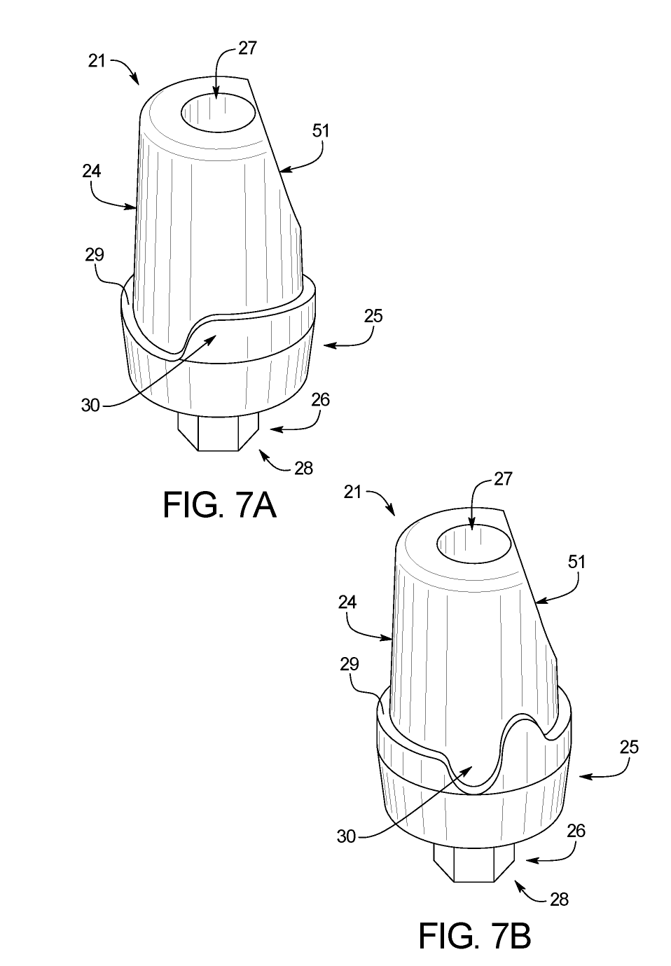

FIG. 7A is perspective view of a preformed abutment 21 with an external indexing feature 30 and internal alignment feature 51. As shown in FIG. 3A, the preformed abutment 21 may feature on its exterior one or more external indexing features 30. The external indexing feature 30 in this example is a marked change in elevation located on the abutment's 21 abutment margin 29. A crown 22 will fit over this abutment 21, with the external indexing feature 30 fitting into a correspondingly sized groove in the crown 22. The crown 22 will also feature a corresponding internal mating surface for the internal alignment feature 51 which further enables proper seating of the crown 22.

FIG. 7B is perspective view of a preformed abutment 21 with two external indexing features 30 and an internal alignment feature 51. As shown in FIG. 3B, the preformed abutment 21 may feature on its exterior one or more external indexing features 30. The external indexing feature 30 in this example is a divot and bump located next to one another on the abutment's 21 abutment margin 29. A crown 22 will fit over this abutment 21, with the external indexing features 30 matching up with complementary grooves, bumps, etc. on the crown 22. The crown 22 will also feature a corresponding internal mating surface for the internal alignment feature 51 which further enables proper seating of the crown 22.

It should be noted that various changes and modifications to the presently preferred embodiments described herein will be apparent to those skilled in the art. Such changes and modifications may be made without departing from the spirit and scope of the present invention and without diminishing its attendant advantages.

I claim:

1. A dental implant abutment comprising:
a crown seating portion located toward a first end of the abutment;
a fixture seating portion located toward a second end of the abutment; and
a main body located between the crown seating portion and the fixture seating portion, the main body including an external indexing feature located along an outer perimeter of the main body at a transition between the main body and the crown seating portion, the external indexing feature comprising an elevational variance of the outer perimeter of the main body that mates with a visually identifiable elevational variance of a mating surface of a crown with which the dental implant abutment mates.

2. The dental implant abutment of claim 1, wherein the visually identifiable elevational variance of the outer perimeter of the main body extends toward the crown seating portion.

3. The dental implant abutment of claim 1, wherein the visually identifiable elevational variance of the outer perimeter of the main body extends away from the crown seating portion.

4. The dental implant abutment of claim 1, wherein the visually identifiable elevational variance comprises at least two visually identifiable elevational variances of the outer perimeter of the main body.

5. The dental implant abutment of claim 4, wherein the at least two visually identifiable elevational variances comprise at least one visually identifiable elevational variance that extends toward the crown seating portion and at least one visually identifiable elevational variance extends away from the crown seating portion.

6. The dental implant abutment of claim 5, wherein the at least two visually identifiable elevational variances extend toward the crown seating portion.

7. The dental implant abutment of claim 1 wherein, the crown seating portion further includes an internal alignment feature corresponding with an internal alignment surface of the crown with which the dental implant abutment mates such that, when the dental implant abutment alignment surface aligns with the internal alignment surface of the crown, the dental implant abutment indexing feature aligns with the visually identifiable elevational variance of the mating surface of the crown.

8. The dental implant abutment of claim 7, wherein the visually identifiable elevational variance of the outer perimeter of the main body extends toward the crown seating portion.

9. The dental implant abutment of claim 7, wherein the visually identifiable elevational variance of the outer perimeter of the main body extends away from the crown seating portion.

10. The dental implant abutment of claim 7, wherein the visually identifiable elevational variance comprises at least two visually identifiable elevational variances of the outer perimeter of the main body.

11. The dental implant abutment of claim 10, wherein the at least two visually identifiable elevational variances comprise at least one visually identifiable elevational variance that extends toward the crown seating portion and at least one visually identifiable elevational variance extends away from the crown seating portion.

12. The dental implant abutment of claim 10, wherein the at least two visually identifiable elevational variances extend toward the crown seating portion.

13. The dental implant abutment of claim 7, wherein the internal alignment surface of the crown is a flat surface.

14. The dental implant abutment of claim 7 wherein the internal alignment feature of the abutment is a flat surface.

15. A dental implant abutment comprising:
a crown seating portion located toward a first end of the abutment, the crown seating portion comprising an internal alignment feature corresponding with an internal alignment surface of a crown with which the dental implant abutment mates such that, when the internal alignment feature of the abutment aligns with the internal alignment surface of the crown, a dental implant abutment indexing feature aligns with a visually identifiable elevational variance of the mating surface of the crown;
a fixture seating portion located toward a second end of the abutment; and
a main body located between the crown seating portion and the fixture seating portion, the main body including the external indexing feature located along an outer perimeter of the main body at a transition between the main body and the crown seating portion, the external indexing feature comprising an elevational variance of the outer perimeter of the main body that mates with a visually identifiable elevational variance of a mating surface of a crown with which the dental implant abutment mates.
